(19) United States
(12) Patent Application Publication
(10) Pub. No.: US 2012/0306384 A1
(43) Pub. Date: Dec. 6, 2012

(54) ILLUMINATION DEVICE AND ILLUMINATION SYSTEM

(76) Inventor: CHIA-TEH CHEN, Taipei City (TW)

(21) Appl. No.: 13/153,287

(22) Filed: Jun. 3, 2011

(51) Int. Cl. H05B 37/02; H05B 37/00

(52) U.S. Cl. 315/159; 315/362; 315/313

(57) ABSTRACT

An illumination device is adapted to control a primary illumination device including a wireless receiver module. The said illumination device includes a motion sensor, a light-emitting diode (LED) light source, and a wireless transmitter module. When the motion sensor detects a person entering a detection zone of the illumination device, the illumination device transmits a signal to the primary illumination device through the wireless transmitter module to activate the primary illumination device.

### BACKGROUND OF THE INVENTION

1. Field of the Invention

The present invention relates to a house number lamp capable of motion detection; in particular, to a solar-powered house number lamp having motion detecting capability and a system thereof for remotely monitoring one or more peripheral lighting device.

2. Description of Related Art

House number plates (plaques) are usually placed at visible locations in front of houses to display address numbers. Recently in the United States, five states have passed laws and regulations that require newly built houses to adapt self-illuminating number plaques to provide adequate visibility of the house number, thus enabling drivers and/or pedestrians to better identify house numbers during night time or under low light conditions. Fluorescent or incandescent lighting devices have been the traditional light source for illuminating the house number plate. Recently, using light-emitting diode (LED) as light source, in cooperation with solar power source and further in combination with photo control circuitry to activate the light-emitting diode and provide illumination (during night time or in low light conditions), has been explored in the art.

### SUMMARY OF THE INVENTION

One aspect of the present invention provides an illumination system including a transceiver-equipped automatic house number lamp and at least an illumination device remotely controllable by the automatic house lamp. The house number lamp includes a motion sensor configured to detect an approaching person and programmed to activate illumination automatically. Upon detecting the presence of a passing person, the automatic number lamp can establish remote links to other receiver-equipped external lighting devices (such as wall lamps) to control the activation thereof.

Another aspect of the present invention provides an illumination device adapted to remotely control other receiver-equipped primary illumination device(s). The illumination device includes a motion sensor, a light-emitting diode light source, and a wireless transmitter module. When the motion sensor of the illuminating device detects the entering of a person into a predetermined detection zone, the illumination device transmits a signal to the primary illumination device through the wireless transmitter module to activate the primary illumination device.

Yet another aspect of the present invention provides an illumination system including at least one primary illumination device and a secondary illumination device. The primary illumination device includes a primary light source and a wireless receiver module. The secondary illumination device includes a motion sensor, a light-emitting diode light source, and a wireless transmitter module. When the motion sensor of the secondary illumination device detects a person entering a predetermined detection zone, the illumination device transmits a signal to the primary illumination device through the wireless transmitter module to activate the primary illumination device.

In summary, the instantly disclosed illumination device may be configured to activate the primary illumination device upon the detection of an approaching person, thereby providing smart lighting capability.

In order to further the understanding regarding the present invention, the following embodiments are provided along with illustrations to facilitate the disclosure of the present invention.

### BRIEF DESCRIPTION OF THE DRAWINGS

FIG. 1 shows an illustration of an illumination system including a house number lamp and an external primary illumination device according to the first embodiment of the present invention;

FIG. 2 shows a function block diagram of a house number lamp utilizing an automatic illumination device in accordance with the first embodiment of the present invention;

FIG. 3 shows a function block diagram of an external primary illumination device according to the first embodiment of the present invention;

FIG. 4 shows a diagram of an illumination device in accordance with the second embodiment of the present invention;

FIG. 5 shows a diagram of an illumination device accordance with the third embodiment of the present invention;

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended drawings.

### First Embodiment

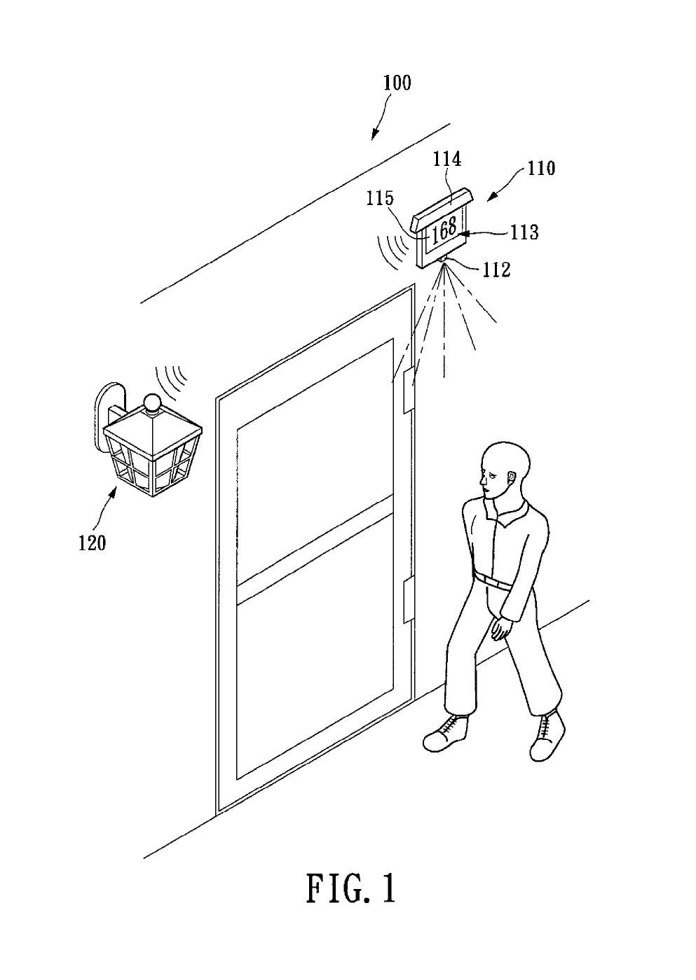

The first exemplary embodiment of the present invention provides a secondary illumination device that can be used in a house number lamp, a garden light, or a column light, etc to cooperate with one or more primary illumination device (such as a wall lamp) in forming a smart lighting system. The first embodiment of the present invention adapts a house number lamp and a wall lamp respectively as the secondary and the primary illumination devices to illustrate the implementation of the instantly disclosed illumination system. Please refer to FIG. 1, which shows an illustration of the illumination system in accordance with the first embodiment of the present invention. The illumination system 100 includes a house number lamp 110 and a wall lamp 120, wherein the wall lamp 120 serves as the primary illumination device and the house number lamp 110 serves as the secondary illumination device. The house number lamp 110 includes a motion sensor 112 and a wireless transmitter module (not shown) for detecting the presence of an approaching person and transmitting control signal accordingly. The wall lamp 120 includes a wireless receiver module (not shown) adapted to receive signals transmitted by the house number lamp 110. When the motion sensor 112 of the house number lamp 110 detects a person entering the detection zone thereof, the house number lamp 100 would automatically transmit signals to the wall lamp 120 through the wireless transmitter module to activate the wall lamp 120, thereby generating light.

The house number lamp 110 may incorporate photo control capability. Particularly, the activation of the illumination source 115 of the house number lamp 110 may be triggered according to the brightness of the ambient lighting conditions. For example, when the brightness of the ambient light is lower than a predetermined threshold value (indicating too dark or entering night time), the illumination source 115 of the house number lamp 110 will be activated to illuminate the house number 113. Thus, the house number lamp 110 may be configured to stay lit during the night and automatically shut off during the day. In addition, the house number lamp 110 may be powered by a conventional household AC power source or by a solar panel module 114. The solar panel module 114 is preferably installed on the upper portion of the house number lamp 110. During the day, the solar panel module 114 may convert solar energy into electricity to charge a built-in battery. During the night, the built-in battery of the solar panel module 114 can then supply power to the house number lamp 110. It is noteworthy that, the solar panel 114 and the house number lamp 110 may be either structurally integrated or separated. For example, the main body of the solar panel module 114 may be installed on the roof or places receiving sufficient sunlight, then through a pre-arranged power line transferring electricity to the main body of the house number lamp 110. The installation location of the solar panel module 114 and methods for powering the house number lamp 110 are not limited thereto in the present invention.

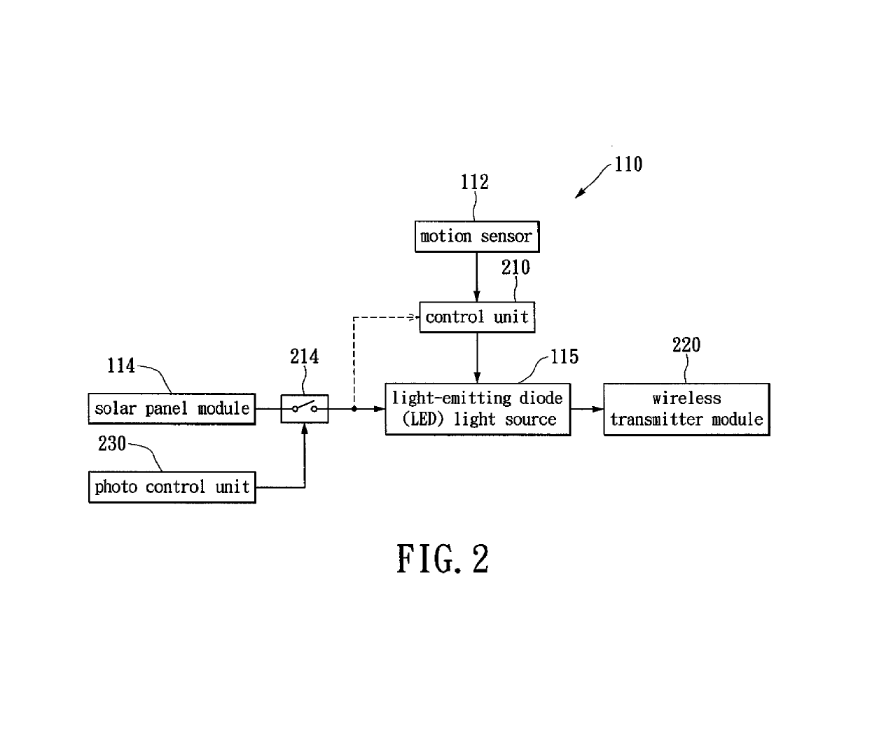

Please refer to FIG. 2 in conjunction with FIG. 1. FIG. 2 shows a function block diagram of the house number lamp 110 in accordance with the first embodiment of the present invention. The house number lamp 110 includes a motion sensor 112, a solar panel module 114, a light-emitting diode light source 115, a control unit 210, a wireless transmitter module 220, and a photo control unit 230. The control unit 210 is coupled to the motion sensor 112, the light-emitting diode light source 115, and the wireless transmitter module 220. The electricity generated by the solar panel module 114 may be supplied to power the associated components of the house number lamp 110. The LED light source 115 may include a high brightness LED, but the exact type, number, and arrangement of LED depends on specific design and/or operational requirement and shall not be limited to the examples provided by the instant embodiment. The motion sensor 112, for example, can be a Passive Infrared Sensor (PIR) or a Microwave Sensor. However, the present invention is not limited thereto. The control unit 210 can be implemented by a microcontroller or an embedded IC. However, the present invention is not limited thereto. The transmitter module 220 may include a digital encoder unit, a high frequency modulation unit, a high frequency transmitter unit, and an antenna (not show in instant figures). The circuitry structure of the transmitter module 220 may be realized by a conventional transmitter module or a transceiver module. However, the type of circuit structure adopted for the wireless transmitter module 220 is not limited to the examples provided by the instant embodiment. The wireless transmitter module 220 may operate in the frequency range of the Industrial, Scientific and Medical (ISM) Radio Bands, for example, the 2.4 GHz band range. However, the specific frequency bandwidth for the transmitter module depends on specific design and/or operational requirements and should not be limited to examples provided herein.

The light-emitting diode light source 115 is primarily for illuminating the house number 113. During night time, the house number lamp 110 may automatically turn on the LED light source 115. During daytime, the LED light source 115 will turn off automatically. The control unit 210 may be configured to control the wireless transmitter module 220 to transmit signal to activate/deactivate the receiver-equipped primary illumination device (such as the wall lamp 120) according to the detection result of the motion sensor 112. For instance, when the sensor detects an approaching person, the control unit 210 can transmit signals through the wireless transmitter module 220 to turn on the corresponding wall lamps 120, thus allowing pedestrians or drivers to clearly identify the house number. The number of wall lamp 120 can be one or more, and the quantity of the wall lamp 120 should not be limited by example of the instant embodiment. In addition, the activation duration of the wall lamp 120 may be set to suit particular preferences or meet specific operational requirements, for example, to five or ten seconds. The house number lamp 110 may also transmit a de-activation control signal to turn off the corresponding wall lamp 120 after the wall lamp 120 have been turned on over the preset duration.

The photo control unit 230, which may include a photoresistor, may be adapted for detecting ambient lighting condition and controlling the transmission of electrical energy from the solar panel module 214 to the light-emitting diode light source 115 and the control unit 210. For instance, the photo control unit 230 can control the switch 214 to determine whether or not to provide electricity to the light-emitting diode light source 115 and the control unit 210, thereby deciding whether or not to activate the LED light source 115 and the control unit 210. An exemplary placement of the switch 214 is shown in FIG. 2. However, the circuitry structure shown in FIG. 2 is not intended as limitation on the scope of the present invention. During night time, the photo control unit 230 can activate the light-emitting diode light source 115 to achieve the auto-illumination effect. During daytime, the photo control unit 230 can automatically turn off the light-emitting diode light source 115, the control unit 210, and the wireless transmitter module 220 to save electricity. The light-emitting diode light source 115 can be controlled by either the photo control unit 230 or the control unit 210. Further, it is noteworthy that the solar panel module 114 can have built-in detection circuitry and can determine whether to charge the built-in battery or to supply electricity to the light-emitting diode light source 115 from the built-in battery through detecting the magnitude of the output current of the solar panel module 114.

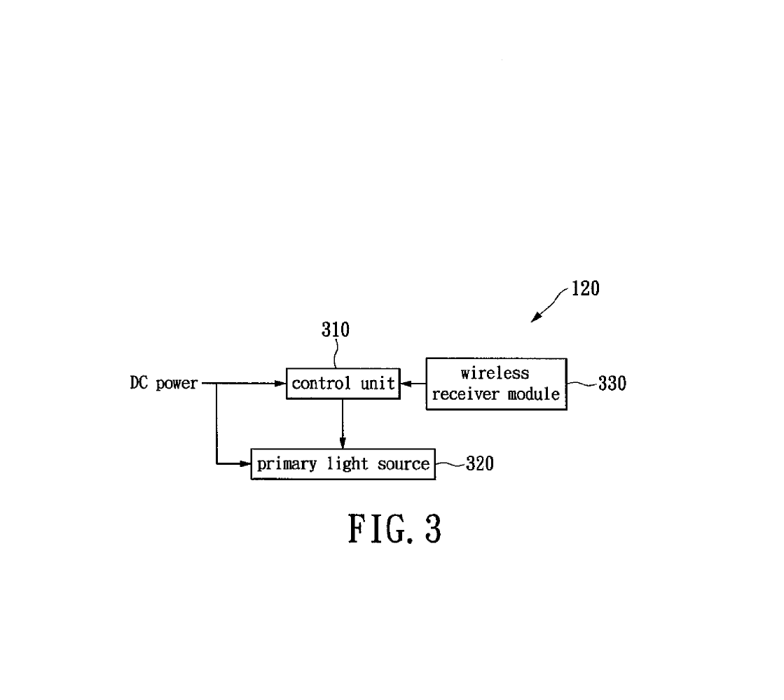

Next, please refer to FIG. 3, which shows the function block diagram of an external primary illumination device in accordance with the first embodiment of the present invention. The wall lamp 120 includes a control unit 310, a primary light source 320, and a wireless receiver module 330. The control unit 310 is for controlling the activation of the primary light source 320. The wall lamp 120 can receive the signal transmitted by the house number lamp 110 through the wireless receiver module 330 and decide whether or not to activate the primary light source 320. It is noteworthy that the control unit 310 and the wireless receiver module 330 of the present embodiment can be integrated into a single module to control the power of the light source. Moreover, with the installation of the control unit 310 and the wireless receiver module 330 described herein, a conventional lighting device can be brought under control of the instantly disclosed secondary illumination device (for example, the house number lamp 110) and therefore conveniently integrated into the smart lighting system. The house number lamp 110 may concurrently control one or more control-module-equipped primary illumination device (such as the wall lamp 120) within range, for example, the lamp in the garden or the lamp in the garage. The exact quantity, type, and arrangement of lighting device for the primary (such as wall lamp 120) and the secondary illumination devices should not be limited by the example of the instant embodiment.

The primary illumination device (the wall lamp 120) can be activated by the secondary illumination device, and the activation duration can be set according to the particular preference or specific operational needs. For example, the activated period of the wall lamp 120 may be set to five to ten seconds, just enough to provide illumination for a returning house owner as he/she enters the door. However, the present invention is not limited thereto. For example, the control unit 310 of the wall lamp 120 may include a microcontroller programmed to provide multiple modes of illumination, or to automatically determine the activating duration of the illuminating device. Further, the electronic components of the aforementioned house number lamp 110, such as the control unit 210, the motion sensor 112, the wireless transmitter 220, and the photo control unit 230, can be integrated into a single lamp control module for the ease of installation. Further, the house number lamp 110 can also utilize the wireless light modulator to carry out partial circuit functionalities of the house number lamp 110 or the wall lamp 120. However, the circuitry implementations for the house number lamp 110 and the wall lamp 120 are not limited in the present invention.

The house number lamp 110 of the first embodiment of the present invention contains electronic modules having the abilities to detect the presence of an approaching person and in accordance remotely control other lighting equipments. Moreover, the circuitry structure thereof can be integrated into other ordinary external lamps or illumination devices to provide the same functionalities as the house number lamp 110. For instance, the circuitry structure in FIG. 2 (except the light-emitting diode light source 115) can be integrated into a remote lamp control module, while the control unit of 310 and the wireless receiver module 330 in FIG. 3 can be integrated into a controlled module. The remote lamp control module can be applied to garden lamps or any other outdoor lamps, whereas the controlled module can be applied on other lamps. Lamps with the remote lamp control module can then be used to control the lamp equipped with the controlled module. However, please note that, the exact type of lamp adapted thereto is not limited to the scope of the instant example.

### Second Embodiment

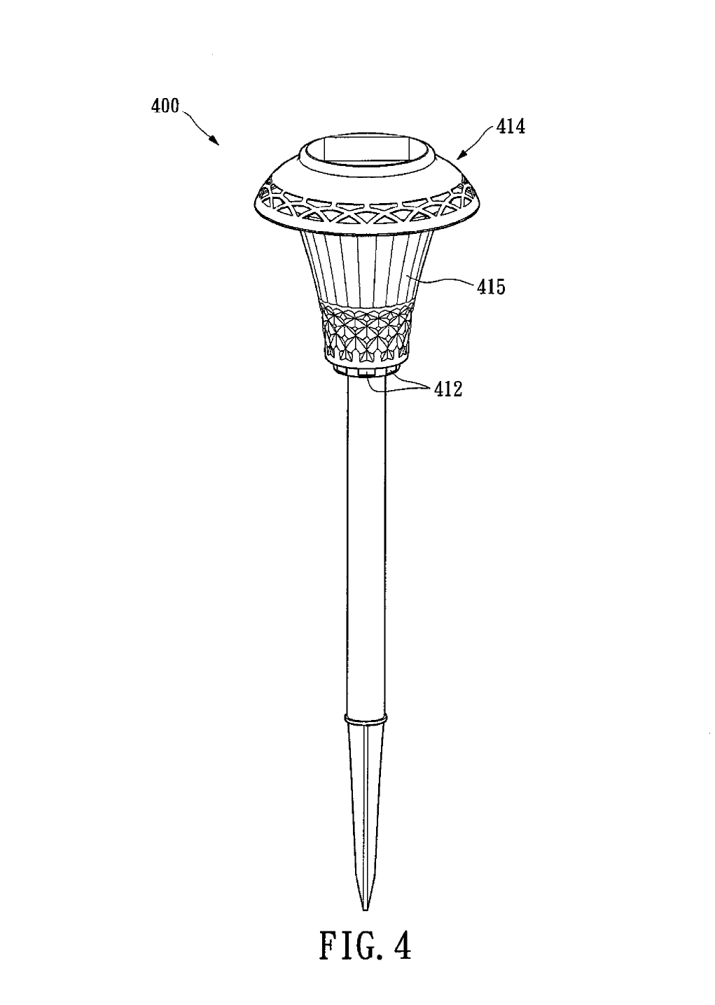

Please refer to FIG. 4, which shows a diagram of an illumination device in accordance with the second exemplary embodiment for the present invention. In the second embodiment, the remote lamp control module discussed above is integrated into an illumination device 400 in the form of a garden lamp. The solar panel module 414 can be placed on the upper portion of the illumination device 400, the light-emitting diode light source 415 can be placed inside the lamp shade, and the motion sensor 412 can be placed at the neck location of the structure. Please note that, FIG. 4 is only an exemplary embodiment for the present invention, and the present invention is not limited thereto. The illumination 400 can be used to control other primary illumination devices such as the wall lamp 120. The operation theory of the illumination device 400 is essentially the same as that of the previous exemplary embodiment, hence from the explanation of the aforementioned embodiment, those skilled in the art should be able to deduce other embodiments according to the disclosure of the present invention, and the description is therefore omitted.

### Third Embodiment

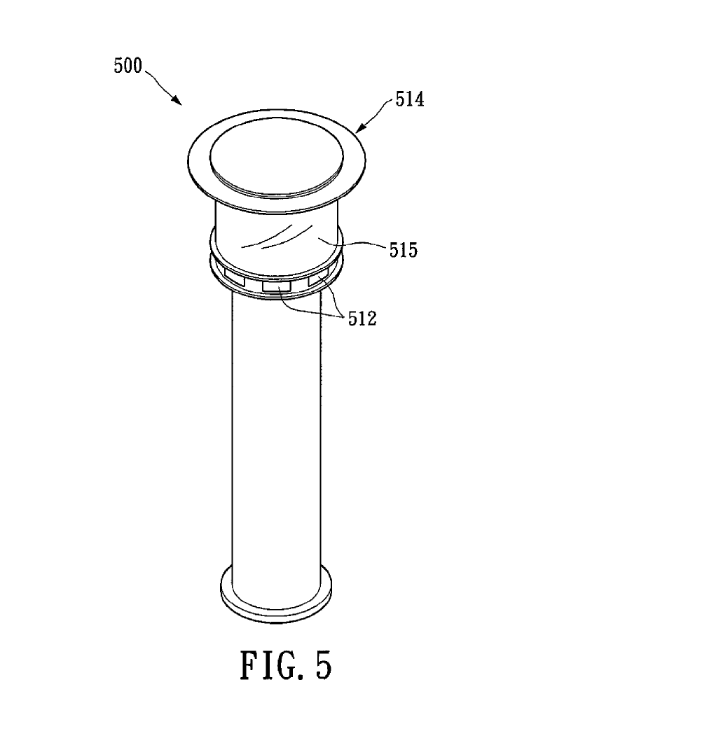

Please refer to FIG. 5, which shows a diagram of an illumination device illustrating the third exemplary embodiment for the present invention. In the third embodiment, the illumination device 500 takes the form of a column lamp. The solar panel module 514 can be installed on the top of the illumination device 500, the LED light source 515 can be placed inside the lamp shade, and the motion sensor 512 can be place at the neck portion of the lamp structure. The operation theory for the illumination device 500 is essentially the same as the one described in the first exemplary embodiment, hence from the explanation of the aforementioned embodiment, those skilled in the art should be able to deduce other embodiments according to the disclosure of the present invention, and the description is therefore omitted.

In the present invention, the aforementioned garden lamp and column lamp shown in FIG. 4 and FIG. 5 may be further operated by additional external manual switch (not shown) to enable convenient optional manual operation. Please note that, the aforementioned descriptions merely represent exemplary embodiments of the present invention, and is not intended to limit both the mechanical and electrical implementations of the manual switch. From the explanation of the aforementioned embodiment, those skilled in the art should be able to deduce the other embodiments according to the disclosure of the present invention, and further description is therefore omitted.

It is noteworthy that the coupling connections among the aforementioned components may include either direct or indirect electrical connections, and the scope of the present invention does not limit the type of connection employed as long as the choice of connection selected is able to fulfill the electrical signal transmission functionality. The techniques described in the aforementioned embodiments can be combined or used independently. Furthermore, the associated components can be added, deleted, modified, or replaced, based on the needs of specific design and functional requirements, and the scope of the present invention should not limited thereto. From the explanation of the aforementioned embodiment, those skilled in the art should be able to deduce the other embodiments according to the disclosure of the present invention, and further description is therefore omitted.

In summary, the house number lamp of the present invention possesses the abilities to detect an approaching person and to remotely control one or more lamps. Furthermore, the house number lamp can automatically self-illuminate based on the preferences and needs of a user and at the same time control the corresponding lamp(s), thereby achieving smart lighting effect.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. An illumination device, adapted to control a primary illumination device including a wireless receiver module, comprising:
a motion sensor;
a light-emitting diode light source; and
a wireless transmitter module;
wherein when the motion sensor detects a person entering into a detection zone of the illumination device, the illumination device transmits a signal to the primary illumination device through the wireless transmitter module to activate the primary illumination device.

2. The illumination device according to claim 1, wherein the illumination device is a house number lamp and of which the light-emitting diode light source is for illuminating a house number on the house number lamp.

3. The illumination device according to claim 1, further comprising a control unit for controlling the wireless transmitter module to transmit the signal to the primary illumination device according to a detection signal outputted from the motion sensor.

4. The illumination device according to claim 1, further comprising:
a solar panel module for providing electricity to the illumination device; and
a photo control unit for making a decision on whether or not to activate the light-emitting diode light source according to the brightness of the ambient light;
wherein when the brightness of the ambient light lower than a predetermined threshold is detected, the photo control unit activates the light-emitting diode light source.

5. The illumination device according to claim 1, wherein the illuminate device is a garden lamp or a column lamp, and the primary illumination device is a wall lamp.

6. The illumination device according to claim 1, wherein the power for the illumination device can be provided from an AC power source or the solar panel module.

7. The illumination device according to claim 3, wherein the control unit is a microcontroller which is programmable to execute multiple illumination modes.

8. An illumination system, comprising:
a primary illumination device including a primary light source and a wireless receiver module; and
a secondary illumination device including a motion sensor, a light-emitting diode light source and a wireless transmitter module;
wherein when the motion sensor detects a person entering a detection zone of the secondary illumination device, the illumination device transmits a signal to the primary illumination device through the wireless transmitter module to activate the primary illumination device.

9. The illumination system according to claim 8, wherein the secondary illumination device is a house number lamp and of which the light-emitting diode light source is for illuminating a house number of the house number lamp.

10. The illumination system according to claim 8, the secondary illumination device further comprising a control unit for controlling the wireless transmitter module to transmit the signal to the primary illumination device according to a detection signal outputted from the motion sensor.

11. The illumination system according to claim 8, wherein the secondary illumination device further comprising:
a solar panel module for providing electricity to the illumination device; and
a photo control unit for making a decision on whether or not to activate the light-emitting diode light source according to the brightness of the ambient light;
wherein when the brightness of the ambient light lower than a predetermined threshold is detected, the photo control unit activates the light-emitting diode.

12. The illumination system according to claim 8, wherein the secondary illumination device is a garden lamp or a column lamp, and the primary illumination device is a wall lamp.

13. The illumination system according to claim 8, wherein the power for the secondary illumination device can be provided from an AC power source or the solar panel module.

14. The illumination system according to claim 10, wherein the control unit is a microcontroller which is programmable to execute multiple illumination modes.
